(19) United States
(12) Patent Application Publication
(10) Pub. No.: US 2008/0141988 A1
(43) Pub. Date: Jun. 19, 2008

(54) METHOD OF CONTROLLING POST INJECTION IN DIESEL ENGINE

(76) Inventor: Jong Ik Jeon, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/845,203

(22) Filed: Aug. 27, 2007

(30) Foreign Application Priority Data
Dec. 15, 2006 (KR) 10-2006-0128760

(51) Int. Cl. F02D 41/30

(52) U.S. Cl. 123/674

(57) ABSTRACT

A method of controlling post injection in a diesel engine, including: storing an engine coolant temperature and a Selective Catalytic Reduction (SCR) temperature when the engine is turned off; calculating an SCR temperature and a coolant temperature when the engine is restarted, based on the temperatures when the engine is turned off, and if the coolant temperature when restarting is higher than a reference coolant temperature, and the SCR temperature when restarting is below a reference SCR temperature, using the SCR temperature when restarting as a factor in controlling the post injection.

### CROSS-REFERENCE TO RELATED APPLICATION

This application claims the benefit under 35 U.S.C. §119(a) of Korean Patent Application No. 10-2006-0128760, filed on Dec. 15, 2006, the entire contents of which are incorporated herein by reference.

### BACKGROUND OF THE INVENTION

1. Field of the Invention

The present invention relates to a method of controlling post injection in a diesel engine and, more particularly, to using coolant temperature and temperature of an SCR (Selective Catalytic Reduction) catalyst as determinative factors for controlling the post injection.

2. Description of Related Art

Because of superior fuel efficiency, diesel engines are becoming widely used, for example in RVs and passenger cars. In order to apply the diesel engine to a passenger car, it is necessary to decrease size and increase rotation speed of the engine. As the diesel engine is shrunk and driven at higher speed, time and space for mixing fuel and air are reduced, which causes problems in optimizing a flow field and a spray field.

The information disclosed in this Background of the Invention section is only for enhancement of understanding of the background of the invention and should not taken as an acknowledgement or any form of suggestion that this information forms the prior art that is already known to a person skilled in the art.

### SUMMARY OF THE INVENTION

Embodiments of the present invention provide a method of controlling post injection in a diesel engine that does not use coolant temperature as a factor when restarting after hot soaking. Embodiments of the inventive method use SCR temperature as a factor under restart conditions of a coolant temperature over 60° C. and an SCR temperature below 180° C.

Embodiments of the inventive method include: storing an engine coolant temperature and a Selective Catalytic Reduction (SCR) temperature when the engine is turned off; calculating an SCR temperature and a coolant temperature when the engine is restarted, based on the temperatures when the engine is turned off; and if the coolant temperature when restarting is higher than a reference coolant temperature, and the SCR temperature when restarting is below a reference SCR temperature, using the SCR temperature when restarting as a factor in controlling the post injection.

The coolant temperature when restarting may be calculated by: (coolant temperature when turning off engine)−(outside air temperature)=coolant temperature when restarting*2^{-t/t}; where t is time elapsed since turning off the engine, and t is a constant.

The SCR temperature when restarting may be calculated by: SCR temperature when restarting=(SCR temperature when turning off engine−outside air temperature)*SCR cooling factor f(t)+outside air temperature; where the SCR cooling factor f(t) is a modeled temperature as a function of time.

The reference coolant temperature may be approximately 60° C. and the reference SCR temperature may be approximately 180° C.

### BRIEF DESCRIPTION OF THE DRAWINGS

The above and other features of the present invention will be described with reference to certain exemplary embodiments thereof illustrated the attached drawings in which:

FIG. 1 is a logic diagram of a method of controlling a post injection in a diesel engine in accordance with embodiments of the present invention;

FIG. 2 is a graph illustrating a fast warm-up section by a post injection in a diesel engine; and

FIG. 3 is a graph illustrating a section in which post injection would be impossible if coolant temperature were used as the only factor in controlling post injection.

### DETAILED DESCRIPTION OF PREFERRED EMBODIMENTS

Hereinafter, preferred embodiments of the present invention will be described with reference to the accompanying drawings. The preferred embodiments are provided so that those skilled in the art can sufficiently understand the present invention, which can be modified in various forms, and the scope of the present invention is not limited to the disclosed embodiments.

To optimize flow field and spray field, a common rail direct injection system utilizes an improved electronic controlling technique and a high-pressurizing technique, such that injection time and amount are optimized to provide better fuel atomization. A common rail direct injection system provides high pressure injection by a cam driving mechanism and controls the adjustment of injection timing accurately, thus enhancing the fuel efficiency and stabilizing the exhaust gas.

Fuel injections of the common rail direct injection system include a pilot injection, a main injection and a post injection. The pilot injection injects a small amount of fuel before the main injection to promote combustion of the fuel in the main injection, prevent noise generation due to the direct injection, and provide stabilization of combustion. The main injection generates actual output of the engine, in which the fuel quantity to be injected is determined according to various conditions such as engine torque, engine speed, coolant temperature, intake air temperature, atmospheric pressure, etc.

Post injection is performed after the main injection, and injects a fuel quantity calculated during the period up to 200° ATDC in an expansion stroke or an exhaust stroke into the exhaust gas.

Rather than being burned in the cylinder like the pilot injection and the main injection, the injected fuel in the post injection is evaporated by heat of the exhaust gas, and returned to the combustion chamber through an exhaust gas recirculation (EGR) system to perform the post injection. Moreover, the injected fuel in the post injection activates a catalyst in an exhaust gas purification system. The purification system in a diesel engine system has a disadvantage in activating the catalyst since the temperature of the exhaust gas from a diesel engine is lower than that from a gasoline engine. Therefore, post injection serves to reduce amount of nitrogen oxides (NOx) and hydrocarbons (HC) in the exhaust gas.

An additional injector, or SCR (Selective Catalytic Reduction) catalyst, is provided, using injection of a reductant, such as urea. The amount of post injection is dependant on the state of the engine and the temperature of the catalyst. The engine control logic measures an engine cooling (soaking) time until the engine restarts after the engine is off, to provide information on the engine cooling time when restarting the engine, to be used as a factor to control fuel quantity and post injection, thus improving the startability of the engine and providing stable engine control after starting the engine.

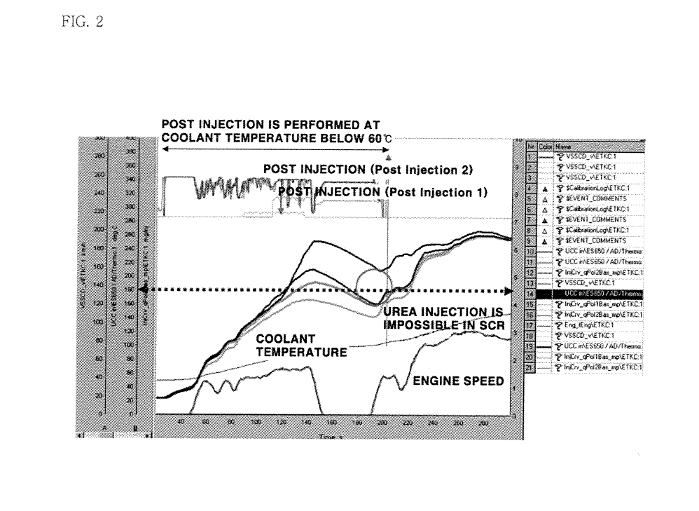

Traditionally, the behavior of the post injection is determined according to the coolant temperature. For example, under cold starting conditions, post injection is performed until the coolant temperature reaches 60° C. For reference, FIG. 2 is a graph depicting a fast warm-up section by post injection, and shows the post injection being carried out up to a coolant temperature of 60° C.

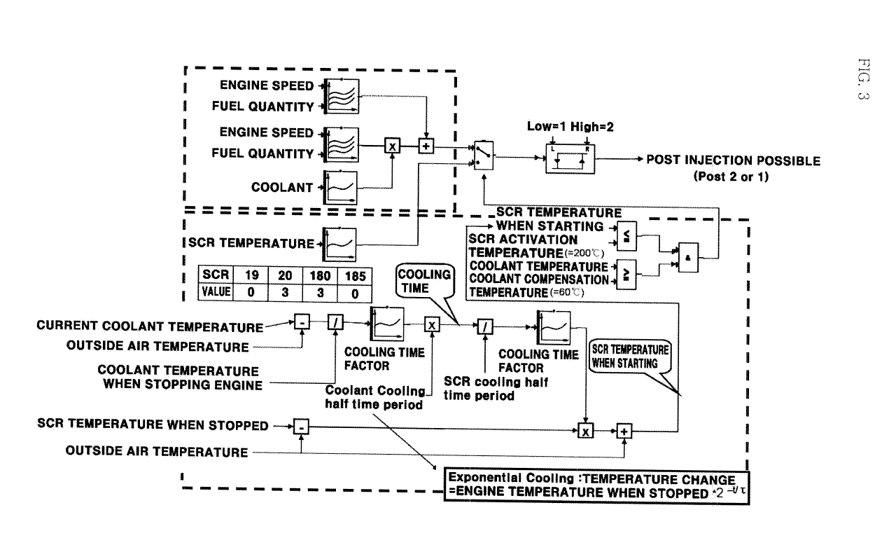

However, during hot soaking of the engine for about 10 minutes, the temperature of coolant does not significantly decrease, while the temperature of the SCR catalyst does decrease. Generally, the coolant temperature remains over 60° C. Referring to FIG. 3, when restarting an engine after hot soaking for about 10 minutes, a fast warm-up of the SCR catalyst by post injection is required, considering that the temperature of the SCR catalyst is below 100° C. However, if the post injection were controlled based only on coolant temperature, this would be impossible, as the coolant temperature is over 60° C.

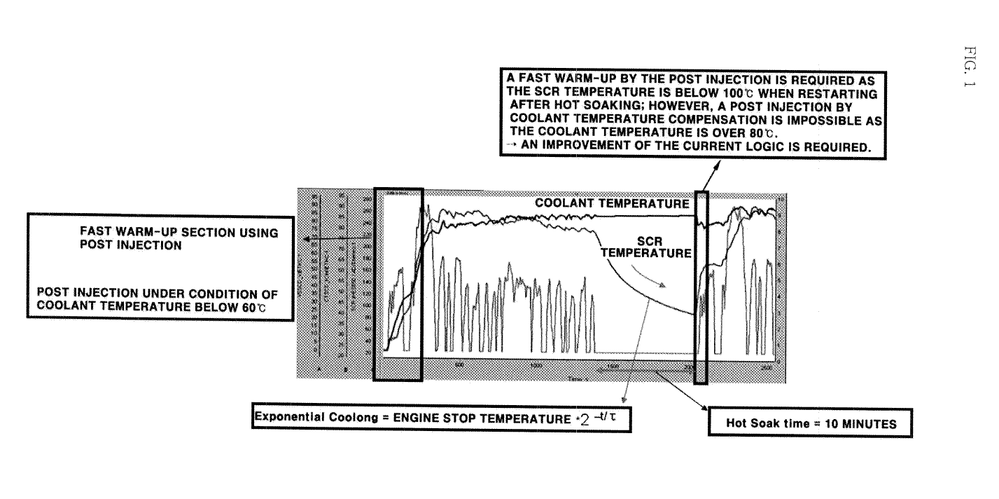

Referring to the conventional logic depicted on the top of FIG. 1, a conventional post injection control system determines a final post injection required amount by calculating the mass of exhaust gas from the current engine speed and the current fuel quantity of the engine, and estimating the mass of the gas being currently exhausted by multiplying the calculated mass of the exhaust gas by a coolant temperature factor.

However, the conventional method has drawbacks in that, since the coolant temperature is high and the SCR temperature is below 100° C. when restarting after hot soaking for about 10 minutes, a fast warm-up of SCR by the post injection is required; however, the post injection by coolant temperature compensation is impossible as the coolant temperature is over 80° C. As a result, as the coolant temperature when restarting is over 60° C., the post injection conditions are not satisfied, thus making post injection impossible.

In contrast, embodiments of the present invention make it possible to perform post injection by providing a switching operation that uses an SCR temperature as a factor in the post injection logic.

For example, if the coolant temperature is over 60° C. and the SCR temperature is below 180° C., exemplary embodiments of the present invention perform post injection until the SCR temperature reaches 180° C.

An exemplary embodiment will now be described in more detail.

First, an engine coolant temperature and an SCR temperature when turning off the engine are stored in an engine control unit (ECU). The ECU may include a processor, memory, and associated hardware, software, and/or firmware as may be selected and programmed by a person of ordinary skill in the art based on the teachings herein. The coolant temperature may be detected by a temperature sensor, and the SCR temperature may be a preset, modeled temperature.

Subsequently, temperature of the coolant when restarting the engine is calculated from:

(coolant temperature when turning off engine)−(outside air temperature)=(coolant temperature when restarting engine)*2^{-t/t}

where t is a time constant, determined experimentally for each vehicle type and stored in the ECU, and where t is the elapsed time since turning off the engine.

As the coolant temperature is high, and the SCR temperature decreases after hot soaking, the SCR temperature when restarting is calculated as follows:

SCR temperature when restarting=(SCR modeled temperature when turning off engine−outside air temperature)*SCR cooling factor f(t)+outside air temperature

where f(t) is the SCR temperature as a function of time, which can be determined experimentally for each vehicle type.

If the coolant temperature is over 60° C. and the SCR temperature is below 180° C., the method switches from using the current engine speed, fuel amount, and coolant temperature as factors to determine the final post injection amount required, to using the SCR temperature as a factor. Accordingly, post injection can be performed until the SCR temperature has reached 180° C.

While preferred embodiments of the present invention have been described and illustrated, the present invention is not limited thereto. On the contrary, it should be understood that various modifications and variations of the present invention can be made by those skilled in the art without departing from the spirit and the technical scope of the present invention as defined by the appended claims.

What is claimed is:

1. A method of controlling post injection in a diesel engine, comprising:
storing an engine coolant temperature and a Selective Catalytic Reduction (SCR) temperature when the engine is turned off;
calculating an SCR temperature and a coolant temperature when the engine is restarted, based on the temperatures when the engine is turned off; and
if the coolant temperature when restarting is higher than a reference coolant temperature, and the SCR temperature when restarting is below a reference SCR temperature, using the SCR temperature when restarting as a factor in controlling the post injection.

2. The method of claim 1, wherein the calculating the coolant temperature when restarting comprises: (coolant temperature when turning off engine)−(outside air temperature)=coolant temperature when restarting*2^{-t/t}; where t is time elapsed since turning off the engine, and t is a constant.

3. The method of claim 1, wherein the calculating the SCR temperature when restarting comprises: SCR temperature when restarting=(SCR temperature when turning off engine−outside air temperature)*SCR cooling factor f(t)+outside air temperature; where the SCR cooling factor f(t) is a modeled temperature as a function of time, and where t is time elapsed since turning off the engine.

4. The method of claim 1, wherein the reference coolant temperature is approximately 60° C. and the reference SCR temperature is approximately 180° C.
